(19) United States
(12) Patent Application Publication
(10) Pub. No.: US 2019/0018305 A1
(43) Pub. Date: Jan. 17, 2019

(54) Case for smart phone & tablet with privacy capability to cover the front and back cameras (No Spy cover case/ No Snoop cover case)

(71) Applicant: Mohamed Gahche, Fairfax, VA (US)

(72) Inventor: Mohamed Gahche, Fairfax, VA (US)

(21) Appl. No.: 15/650,150

(22) Filed: Jul. 14, 2017

(51) Int. Cl. G03B 11/04; H04B 1/3888

(52) U.S. Cl. CPC G03B 11/043; H04B 1/3888

(57) ABSTRACT

It's a case for smart phone and tablet devices designed specifically to provide a feature that will give users a privacy capability to cover the front and back cameras of the device as needed.

The front top of the case will only cover the camera and will leave the other features uncovered such as speaker, sensor, light, and logo.

The back top of the case will have a capability to cover the camera and will keep the rest of the features visible.

The whole case will leave other features uncovered such as on & off button, silent switch, power hole, menu key, home button and back key.

### FIELD

Device cases with a feature that gives the ability to cover the device's camera as needed for privacy purposes.

### BACKGROUND

Available smart device cases today in the market do not provide any camera privacy protection feature to their users. Hackers today can easily break into smart devices and gain access to the camera feature and be able to watch user's activities even when the device is turned off.

### SUMMARY

By providing an optional privacy feature in smart device cases, it will give the user the ability to cover the camera in the front and back of the device when not in use and will allow the user to be worry free from potential spying activities and privacy invasion.

The solution is a case for smart devices to include phones and tablets designed specifically to provide a feature that will give the user a privacy capability to cover the front and back cameras of the device as needed.

The camera part of the case will provide a shutter mechanism that could slide up or down in some cases and left or right in other cases, depending of the location of the camera in the device.

The shutter mechanism will have a handle to facilitate the opening/closing of the camera cover.

### BRIEF DESCRIPTION OF THE DRAWINGS

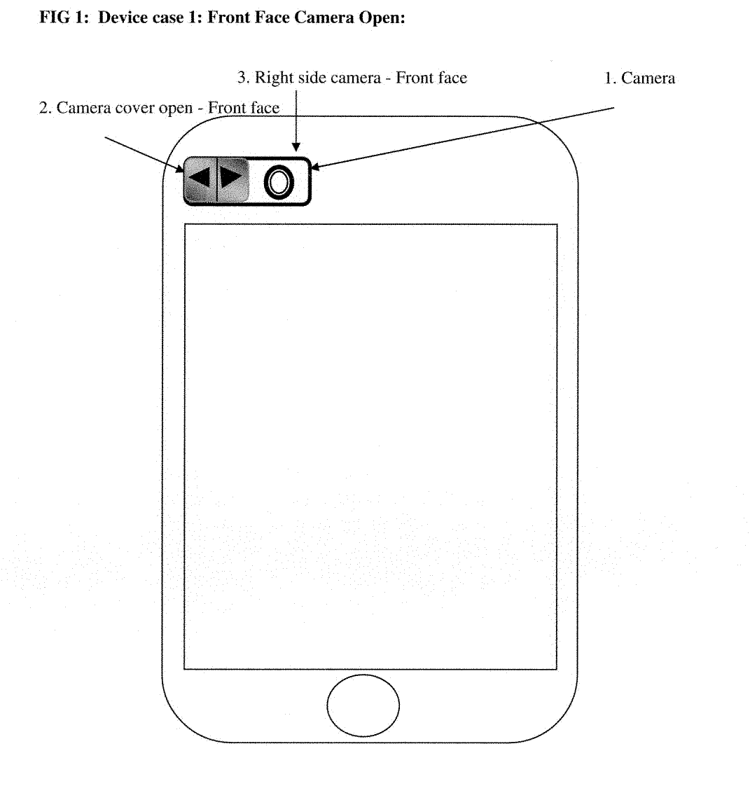

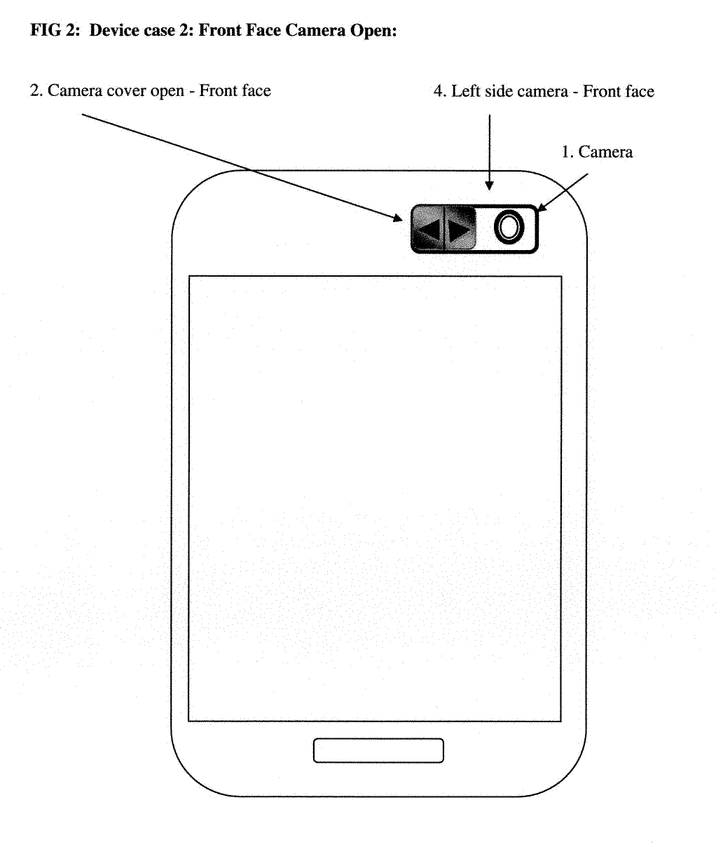

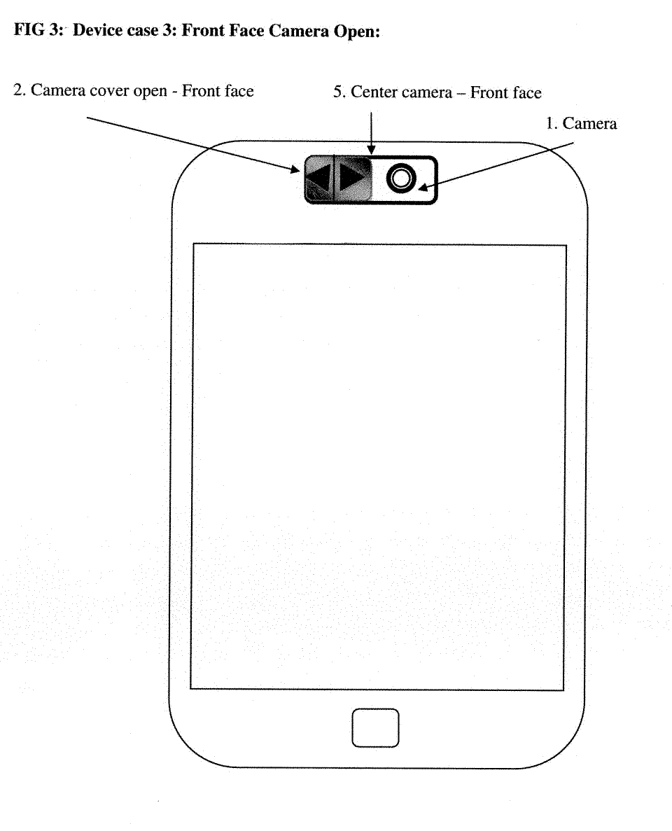

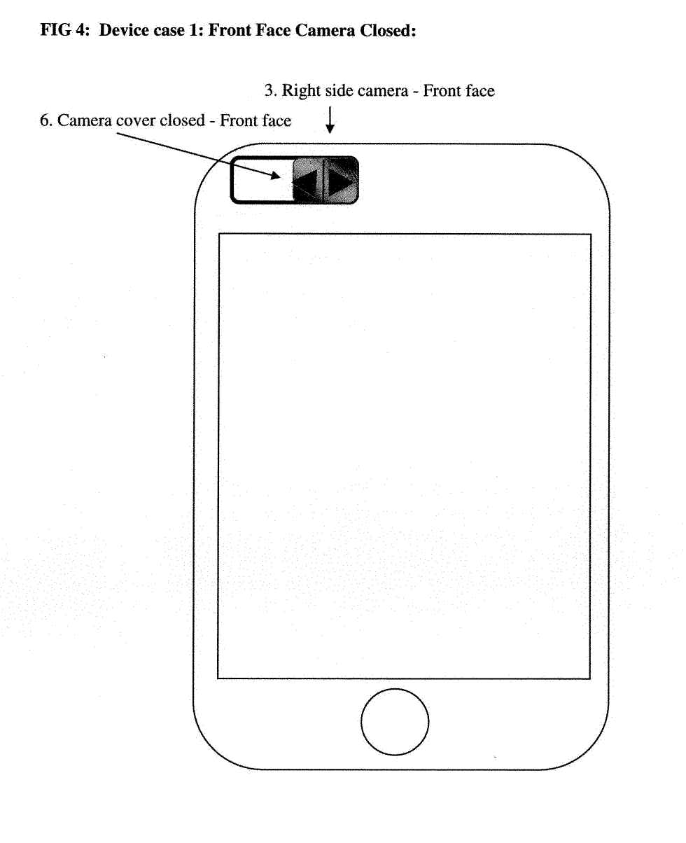

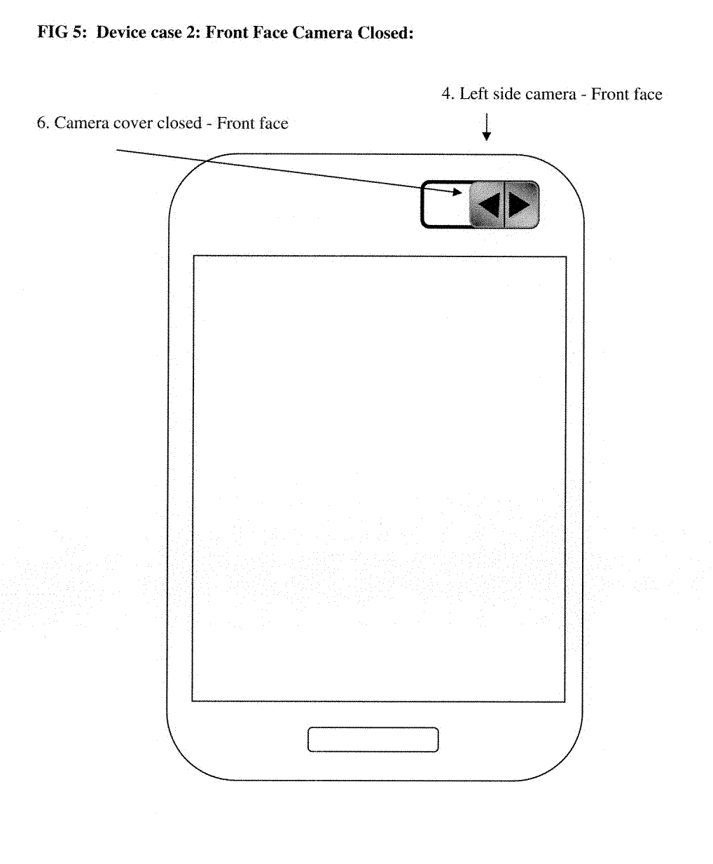

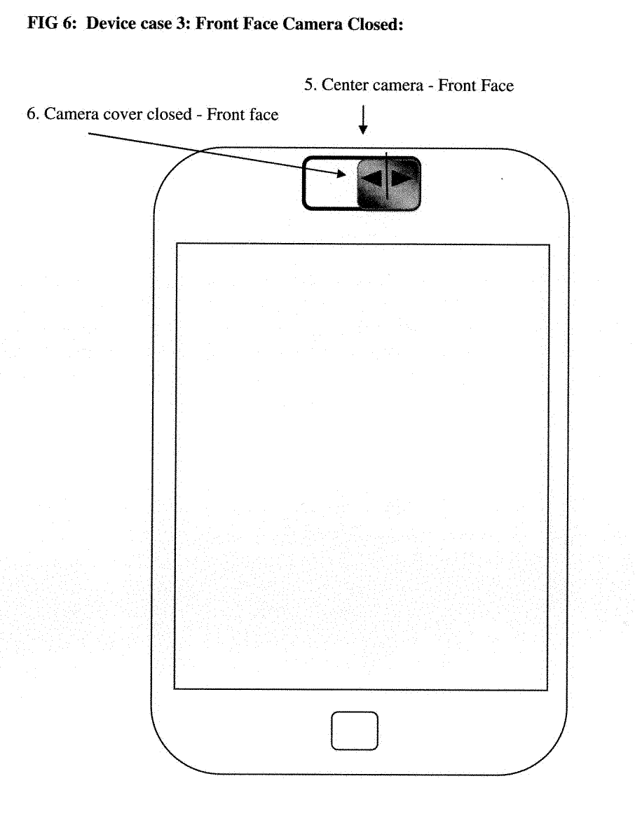

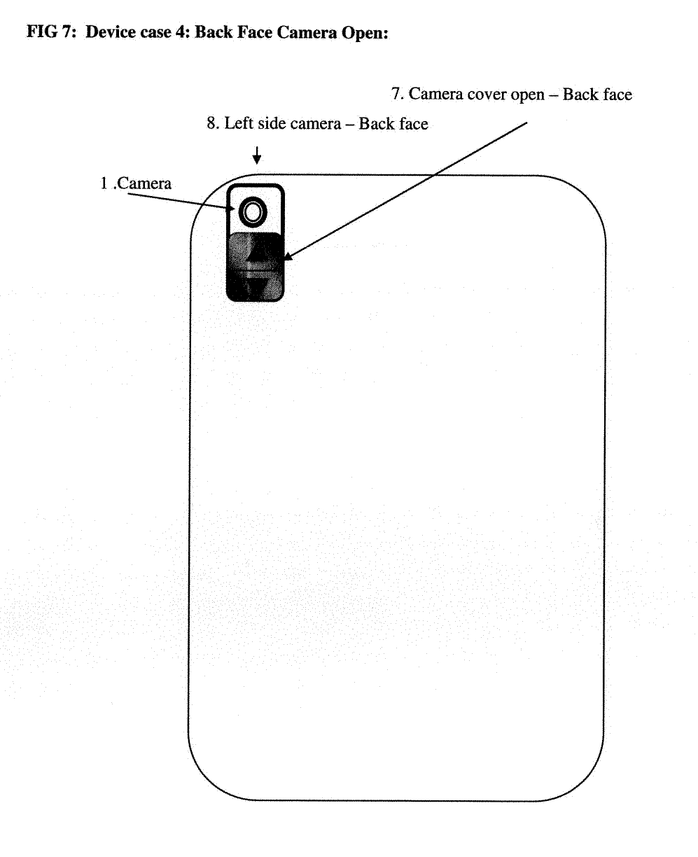

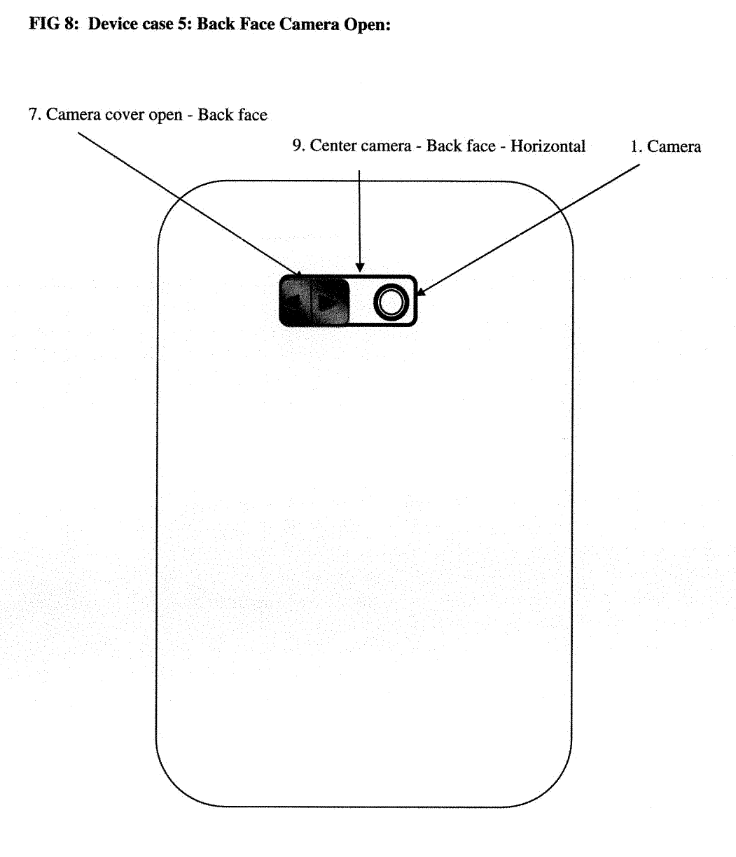

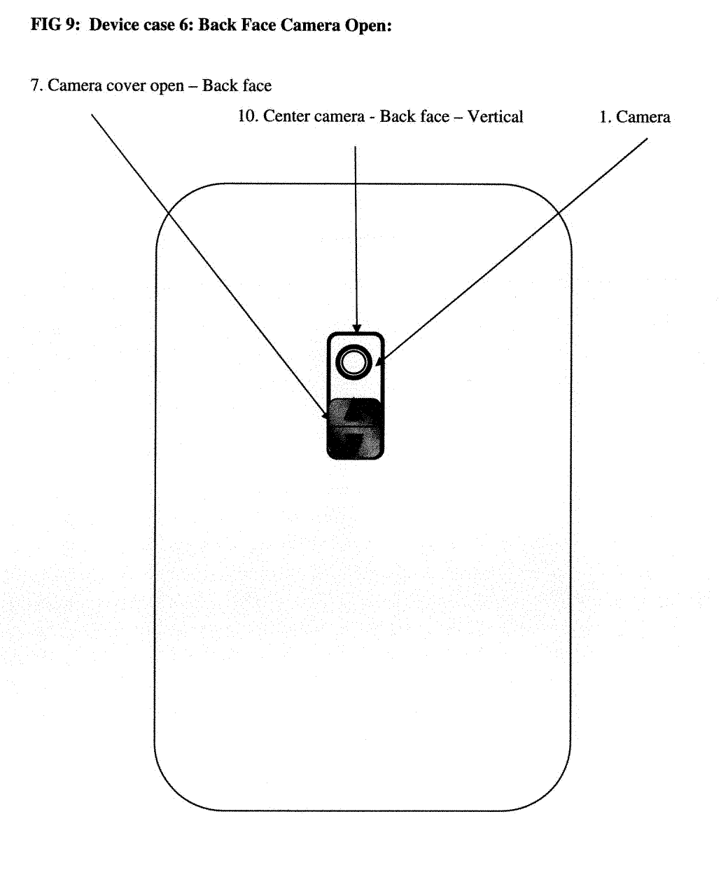

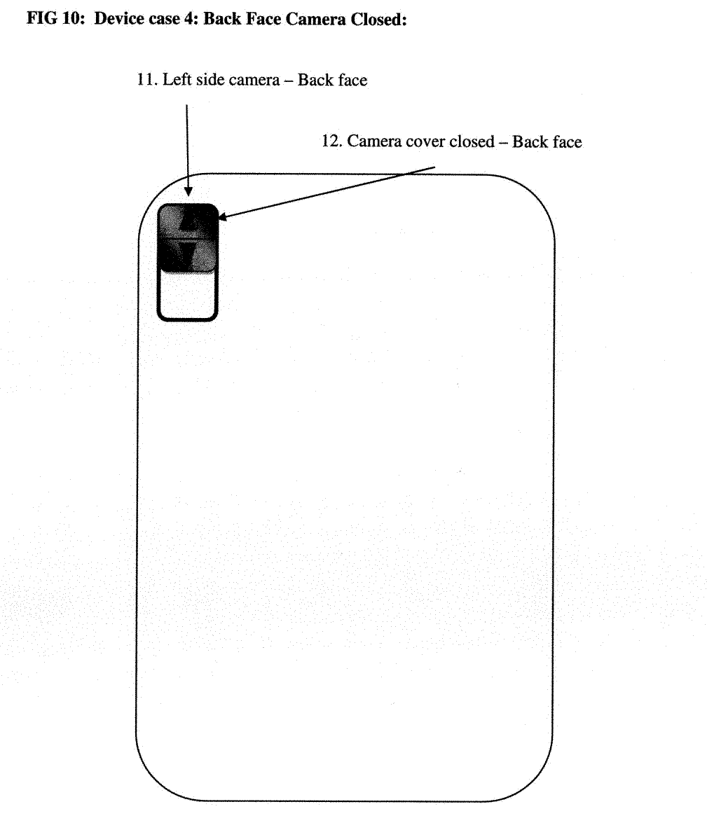

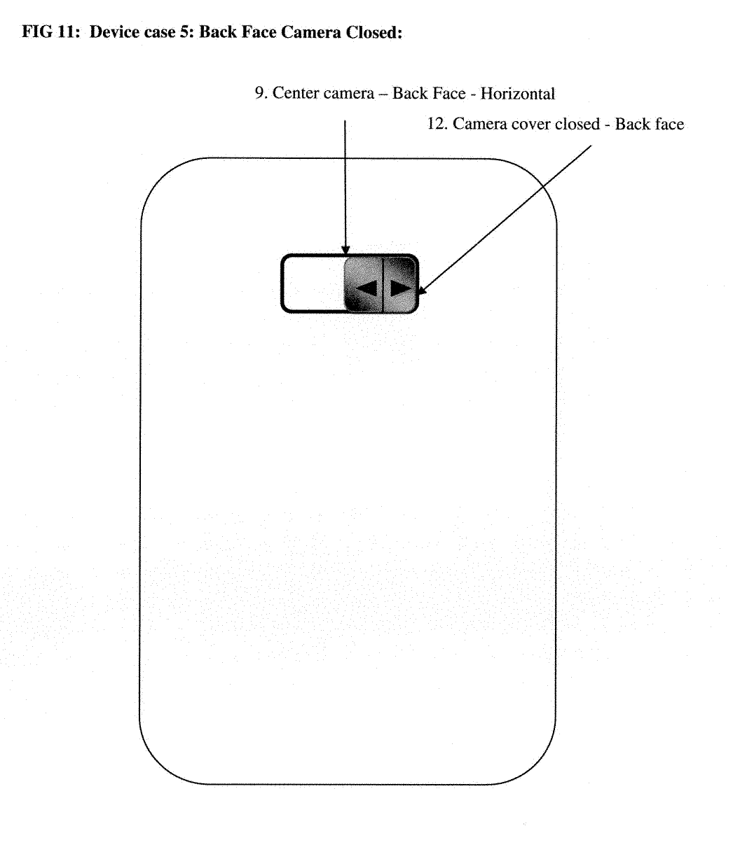

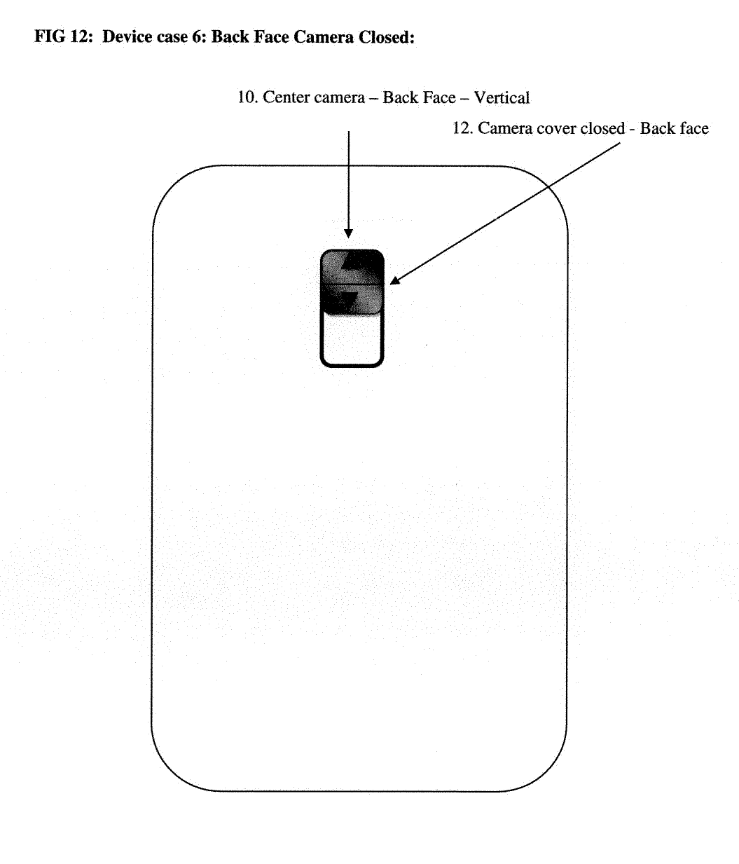

The following figures FIG. 1, FIG. 2, FIG. 3, FIG. 4, FIG. 5, FIG. 6, FIG. 7, FIG. 8, FIG. 9, FIG. 10, FIG. 11, and FIG. 12 are the different devices (Front and back faces) for smart phone and tablet in the market today, where the camera either is located in the front/back upper left, right or in the center. Our cover case will give the user the ability to cover the camera in the front and back of the device when not in use.

### DETAILED DESCRIPTION OF INVENTION

In the following figures are the detailed descriptions of the functionalities of the new device cover case. The case provides a new privacy feature for smart devices (phone or tablet), and will provide protection from potential spying or snooping on users' private lives.

The camera part of the case will provide a shutter mechanism that could slide up or down in some cases and left or right in other cases.

FIG. 1: Front face of the device case (smart phone/tablet) where the camera is located at the upper front face right side of the device. In this example: The camera cover in the front face of the device is open.

FIG. 2: Front face of the device case (smart phone/tablet) where the camera is located at the upper front face left side of the device. In this example: The camera cover in the front face of the device is open.

FIG. 3: Front face of the device case (smart phone/tablet) where the camera is located at the center upper front face of the device. In this example: The camera cover in the front face of the device is open.

FIG. 4: Front face of the device case (smart phone/tablet) where the camera is located at the upper front face right side of the device. In this example: The camera cover in the front face of the device is closed.

FIG. 5: Front face of the device case (smart phone/tablet) where the camera is located at the upper front face left side of the device. In this example: The camera cover in the front face of the device is closed.

FIG. 6: Front face of the device case (smart phone/tablet) where the camera is located at the center upper front face of the device. In this example: The camera cover in the front face of the device is closed.

FIG. 7: Back face of the device case (smart phone/tablet) where the camera is located at the upper back face left side of the device. In this example: The camera cover in the back face of the device is open. The cover in this example is vertical (up or down) due to the location of other device features, for this example the sensor and the light are located next to the camera. In other devices where the camera is not close to other features the camera cover can be horizontal.

FIG. 8: Back face of the device case (smart phone/tablet) where the camera is located at the center upper back face of the device. In this example: The camera cover in the back face of the device is open, and the camera cover is horizontal (left or right).

FIG. 9: Back face of the device case (smart phone/tablet) where the camera is located at the center upper back face of the device. In this example: The camera cover in the back face of the device is open, and the position of the camera cover is vertical (up or down).

FIG. 10: Back face of the device case (smart phone/tablet) where the camera is located at the upper back face left side of the device. In this example: The camera cover in the back face of the device is closed.

FIG. 11: Back face of the device case (smart phone/tablet) where the camera is located at the center upper back face of the device. In this example: The camera cover in the back face of the device is closed, and the camera cover is horizontal (left or right).

FIG. 12: Back face of the device case (smart phone/tablet) where the camera is located at the center upper back face of the device. In this example: The camera cover in the back face of the device is closed, and the position of the camera cover is vertical (up or down).

1. A device case comprising of a front and back privacy feature to allow for a way to cover the front and back cameras when not in use or as needed.

2. A device case according to claim 1, wherein the front of the case covers a section of the top of the device and keeps the rest of the front of the device features visible.

3. A device case according to claim 2, wherein the section where the camera is located has a shutter mechanism that goes either right/left or up/down to cover/uncover the camera.

4. A device case according to claim 2, wherein the section where the speaker is located and other features are kept uncovered and are visible at all times.

5. A device case according to claim 1, wherein the section where the camera is located has a shutter mechanism that either moves left/right or up/down to cover/uncover camera.

6. A device case according to claim 6, wherein the section where the flash light, sensors, and other features are located are kept uncovered and visible at all times.
